(19) United States
(12) Patent Application Publication
(10) Pub. No.: US 2010/0300434 A1
(43) Pub. Date: Dec. 2, 2010

(54) ANESTHESIA TUBE ASSEMBLY

(76) Inventors: Hamid Cyrus Hajarian, Laguna Niguel, CA (US); Modjtaba Ghodoussi, Santa Barbara, CA (US)

Correspondence Address: IRELL & MANELLA LLP, 1800 AVENUE OF THE STARS, SUITE 900, LOS ANGELES, CA, 90067, US

(21) Appl. No.: 12/473,212

(22) Filed: May 27, 2009

(51) Int. Cl. A62B 7/00

(52) U.S. Cl. 128/200.24

(57) ABSTRACT

An anesthesia tube assembly with a fixture that can secure an anesthesia tube to a patient. The fixture can be secured to a patient with a strap. The tube can be inserted into a channel of the fixture.

### BACKGROUND OF THE INVENTION

1. Field of the Invention

The present invention relates to a fixture that secures an anesthesia tube to a patient.

2. Prior Art

Patients under general anesthesia for maxillofacial surgery must be nasally intubated. The tube will go through the nose and into the patient's trachea. The portion of the tube outside of the patient' nose has a 180 degree turn that extends to the patient's forehead. The anesthesia tube must be securely attached to the patient's head to prevent unwanted tube movement. Unwanted movement of the anesthesia tube can create pressure on the nose. This pressure can create necrosis of the cartilage at tip of the nose.

To prevent unwanted movements, the tube is typically secured to the patient's head with gauze and tape. The tape is typically applied to a head drape placed on the patient's head. This approach does not provide a secure attachment of the tube to the patient. Additionally, if there is a desire to move the tube during a procedure the tape must be removed and then reapplied. The removal and reapplication of tape can be a time consuming process, which increases the time required to perform a procedure. It would be desirable to provide a device that can securely hold the tube and also allow for ease of attachment and reattachment of the anesthesia tube to the device and hence to the patient.

### BRIEF SUMMARY OF THE INVENTION

An anesthesia tube assembly that includes a fixture that is secured to a patient. An anesthesia tube is attached to a channel of the fixture.

### BRIEF DESCRIPTION OF THE DRAWINGS

FIG. 1 is a perspective view of a fixture of an anesthesia tube assembly;

FIG. 2 is a perspective view showing the anesthesia tube assembly attached to a patient;

FIG. 3 is an alternate embodiment of the fixture;

FIG. 4 is an alternate embodiment of the fixture;

FIG. 5 is an alternate embodiment of the fixture;

FIG. 6 is an alternate embodiment of the fixture;

FIG. 7 is an alternate embodiment of the fixture.

### DETAILED DESCRIPTION

Disclosed is an anesthesia tube assembly with a fixture that can secure an anesthesia tube to a patient. The fixture can be secured to a patient with a strap. The tube can be inserted into a channel of the fixture. The assembly does not require gauze or tape that is used in prior art methods for securing the tube.

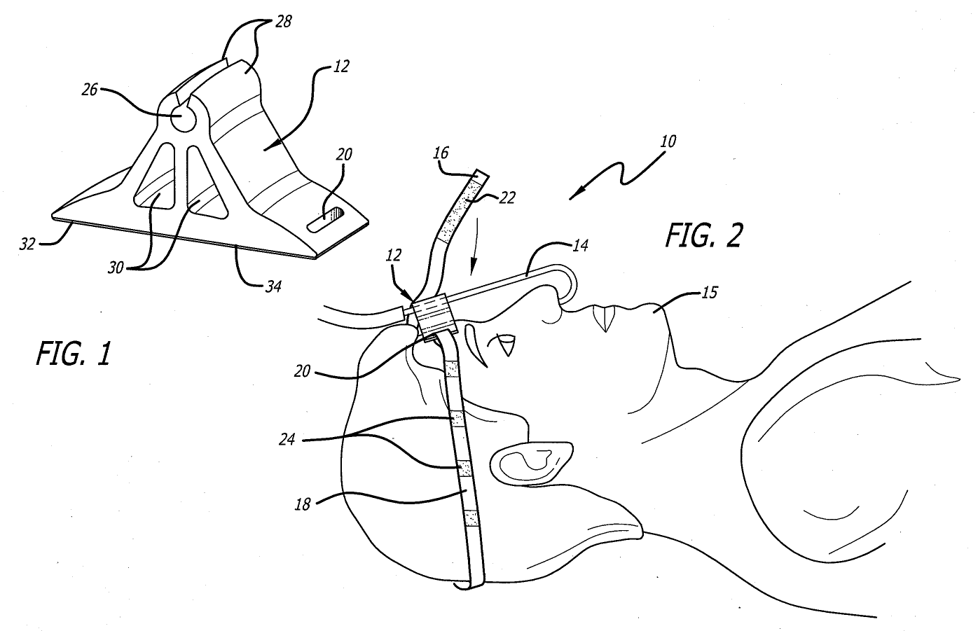

Referring to the drawings more particularly by reference numbers, FIGS. 1 and 2 show an embodiment of an anesthesia tube assembly 10. The assembly 10 includes a fixture 12 that secures an anesthesia tube 14 to a patient 15. The fixture 12 can be secured in place by a strap 18.

One end of the strap 18 can be attached to the fixture 12 at opening 20. The other end of the strap 18 may have hook or loop material 22 that attaches to corresponding loop or hook material 24 on the top of the strap. The strap 18 may be constructed from an elastic material to create a tension force when the fixture 12 is secured to the patient 15. Although hook and loop material is described, it is to be understood that other type of fasteners, such as buttons, snaps, etc. can be used to attach the strap.

The fixture 12 may include a channel 26 formed by a pair of lips 28. The lips 28 are flexible so that the channel 26 can be enlarged to compensate for various diameters of the anesthesia tube 14. By way of example, the entire fixture 12 may be constructed from a molded rubber material. The fixture 12 may further have some relief channels 30.

The fixture 12 may include an adhesive 32 located along a bottom surface 34. The adhesive 32 can be used in addition to, or as an alternative to the strap 18 to secure the fixture to the patient 15. The bottom surface 34 of the fixture 12 may have a curvature that conforms with a forehead of a patient.

To secure the tube 14 to the patient 15, after patient is nasally intubated, the fixture 12 is initially placed on the patient's forehead. The tube 14 is inserted into the fixture channel 26. The strap 18 is then wrapped around the patients head and attached to itself to secure the fixture 12 and tube 14 to the patient 15. Although a certain sequence has been described, it is to be understood that the order of assembly can be varied. For example, the tube 14 may be inserted into the fixture channel 26 before the fixture 12 is placed onto the patient's forehead. The anesthesia tube 14 can be moved by pulling the tube 14 out of the channel 26 and/or unfastening the strap 18 and moving the fixture 12. There is no need to pull up tape as required in the prior art.

FIG. 3 shows an alternate embodiment of a fixture 40 which has compound curvature in directions parallel and transverse to the channel 42. The compound curvature may more readily conform to the curvature of a patient's forehead.

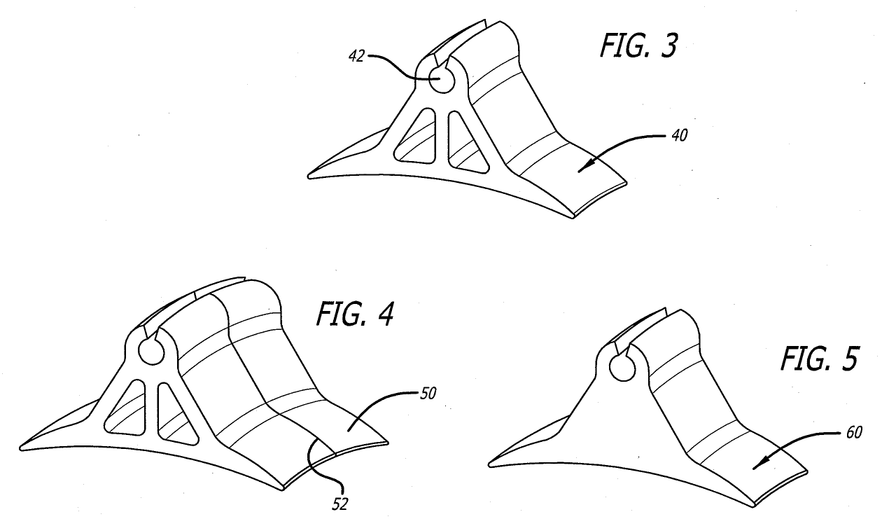

FIG. 4 shows an alternate embodiment of a fixture 50 with a stress relief slit 52. The slit 52 increases the flexibility of the fixture 52 to more readily conform to the patient's forehead.

FIG. 5 is an alternate embodiment of a fixture 60 that does not have relief channels or a compound curvature. This embodiment provides a lower complexity fixture.

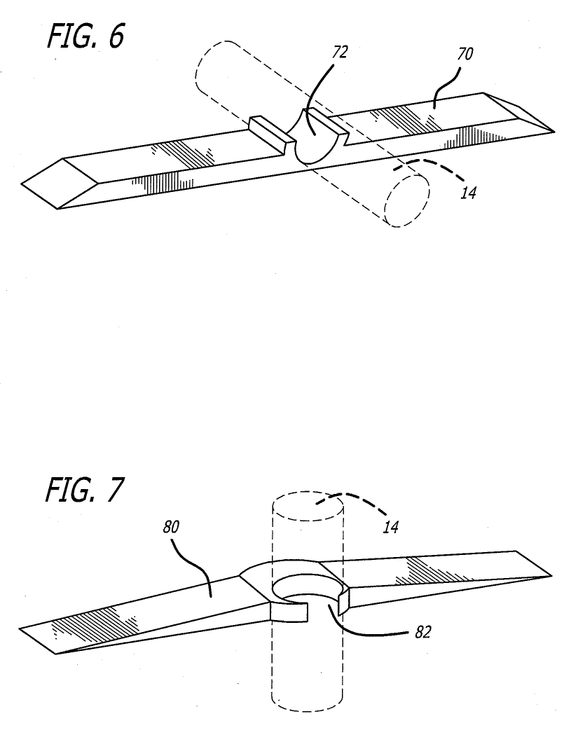

FIG. 6 is an alternate embodiment of a fixture 70 that can be used to secure a tube 14 that is inserted into a patient's mouth. The fixture 70 includes a channel 72 that captures the tube 14. The fixture 70 may include an adhesive 74 so that a strap is not required to secure the device.

FIG. 7 is an alternate embodiment of a fixture 80 that can be used to secure a tube 14 that is inserted into a patient's mouth. The fixture 80 includes a channel 82 that captures the tube 14. The fixture 80 may include an adhesive 84 so that a strap is not required to secure the device.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, although one fixture channel is shown and described, it is to be understood that the fixture may have multiple channels to secure a plurality of tubes.

What is claimed is:

1. A method for attaching an anesthesia tube to a patient, comprising:
placing a fixture onto a patient;
securing the fixture to the patient; and,
attaching the anesthesia tube to the fixture.

2. The method of claim 1, wherein the fixture is secured to the patient with a strap.

3. The method of claim 1, wherein the anesthesia tube is attached to the fixture by inserting the anesthesia tube into a channel of the fixture.

4. The method of claim 1, wherein the fixture includes an adhesive that adheres the fixture to the patient.

5. The method of claim 1, wherein the fixture is attached to a forehead of the patient.

6. An anesthesia tube assembly, comprising:
a fixture that has a channel;
an anesthesia tube that is attached to said fixture within said channel; and,
an attachment device coupled to said fixture.

7. The assembly of claim 6, wherein said attachment device is a strap.

8. The assembly of claim 6, further comprising an adhesive on a bottom surface of said fixture.

9. The assembly of claim 6, wherein said fixture has a compound curvature.

10. The assembly of claim 6, wherein said fixture includes a stress relief slit.

11. An anesthesia tube assembly for a patient, comprising:
a fixture that has a channel;
an anesthesia tube that is attached to said fixture within said channel; and,
attachment means for attaching said fixture to the patient.

12. The assembly of claim 11, wherein said attachment means includes a strap.

13. The assembly of claim 11, wherein said attachment means includes an adhesive on a bottom surface of said fixture.

14. The assembly of claim 11, wherein said fixture has a compound curvature.

15. The assembly of claim 11, wherein said fixture includes a stress relief slit.
